(19) United States
(12) Patent Application Publication
(10) Pub. No.: US 2012/0212585 A1
(43) Pub. Date: Aug. 23, 2012

(54) STEREOSCOPIC IMAGING DEVICE AND STEREOSCOPIC IMAGING METHOD

(75) Inventors: Kenji TERADA, Osaka (JP); Hiroyuki MAKUTA, Osaka (JP); Nobuo IWAI, Osaka (JP)

(73) Assignee: PANASONIC CORPORATION, Osaka (JP)

(21) Appl. No.: 13/397,960

(22) Filed: Feb. 16, 2012

(30) Foreign Application Priority Data
Feb. 22, 2011 (JP) 2011-035660

(51) Int. Cl. H04N 13/02

(52) U.S. Cl. 348/47; 348/E13.074

(57) ABSTRACT

A stereoscopic imaging device includes: a first image capture device and a second image capture device; a convergence point shifter configured to shift a convergence point; and a controller configured to control, in accordance with a zooming-in operation regarding a subject whose images are taken by the first image capture device and by the second image capture device, the convergence point shifter to shift the convergence point rearward or frontward of the subject, and to control, in accordance with a zooming-out operation regarding the subject whose images are taken by the first image capture device and the second image capture device, the convergence point shifter to shift the convergence point frontward or rearward of the subject.

### BACKGROUND OF THE INVENTION

1. Field of the Invention

The present invention relates to a stereoscopic imaging device configured to take a stereoscopic image using two image capture devices, and in particular, to a stereoscopic imaging device configured to change a convergence point in accordance with a zooming operation.

2. Description of the Background Art

Attention has been focused on stereoscopic image (3D image) imaging devices that obtain stereoscopic images by synchronously and independently taking a left eye image and a right eye image. There have been proposed various systems for display devices and viewing methods, and such methods are all based on a basic principle that a stereoscopic effect is provided based on a parallax between the left and the right eyes.

In such a stereoscopic imaging device, it is important to control a convergence point where optical axes of left and right image capture devices cross each other. This is because the sense of projection and the sense of depth of a subject are changed by controlling the convergence point. An example of a technology of controlling the convergence point in accordance with a zooming operation is Patent Literature 1. Patent Literature 1 discloses a method for measuring the distance from a subject to a lens position which is determined by a zoom lens and a focus lens having focused on the subject, and setting the convergence point at the focused position that corresponds to the measured distance.

### CITATION LIST

[Patent Literature 1] Japanese Laid-open Patent Publication No. H8-201940

### SUMMARY OF THE INVENTION

However, in the above technology, since the convergence point is set at the subject on which the lenses have focused, there is an issue that the sense of projection and the sense of depth of the subject cannot be changed. Further, in order to change the convergence point to emphasize the stereoscopic effect while taking an image with the stereoscopic imaging device, additional work is required.

In order to solve the above issues, a stereoscopic imaging device of the present invention is directed to a stereoscopic imaging device configured to obtain a stereoscopic image composed of a left image and a right image, the stereoscopic imaging device comprising: a first image capture device and a second image capture device configured to take the left image and the right image, respectively; a convergence point shifter configured to shift a convergence point of the stereoscopic image provided by the first image capture device and the second image capture device; and a controller configured to perform at least one of controlling, in accordance with a zooming operation, when a subject in the stereoscopic image is to be zoomed in, the convergence point shifter to shift the convergence point rearward of the subject, and, when the subject in the stereoscopic image is to be zoomed out, the convergence point shifter to shift the convergence point frontward of the subject, and controlling, in accordance with a zooming operation, when the subject in the stereoscopic image is to be zoomed in, the convergence point shifter to shift the convergence point frontward of the subject, and, when the subject in the stereoscopic image is to be zoomed out, the convergence point shifter to shift the convergence point rearward of the subject.

According to the above configuration, the stereoscopic imaging device can change the sense of projection and the sense of depth in accordance with a zooming operation, and thus, can take an image with emphasized stereoscopic effects, without requiring additional work for changing the convergence point.

### BRIEF DESCRIPTION OF THE DRAWINGS

FIG. 1 is a block diagram showing a configuration of a stereoscopic imaging device according to embodiment 1;

FIG. 2 is a flow chart showing operations performed by a stereoscopic imaging device in embodiment 1; and

FIG. 3 is a schematic diagram illustrating a method for determining a convergence point in embodiment 1.

### DESCRIPTION OF THE PREFERRED EMBODIMENTS

Hereinafter, an embodiment for implementing the present invention will be described in detail with reference to the drawings.

### Embodiment 1

(1. Configuration of a Stereoscopic Imaging Device)

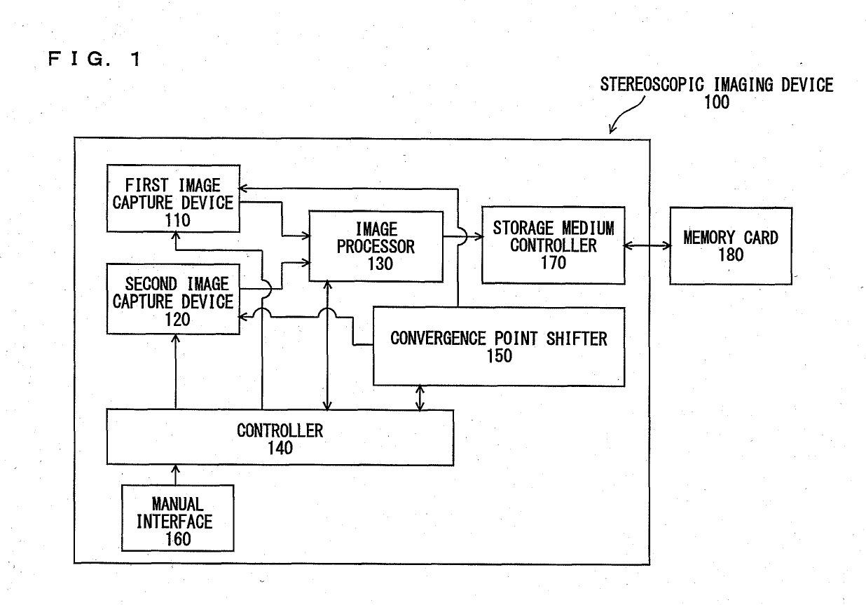

FIG. 1 is a block diagram showing a configuration of a stereoscopic imaging device 100 according to embodiment 1. In FIG. 1, the stereoscopic imaging device 100 includes a first image capture device 110, a second image capture device 120, an image processor 130, a controller 140, a convergence point shifter 150, a manual interface 160, and a storage medium controller 170. A memory card 180 is connected to the stereoscopic imaging device 100 via the storage medium controller 170.

The first image capture device 110 and the second image capture device 120 are arranged with a predetermined interval therebetween. The predetermined interval is often set to approximately 65 mm, which is an interval between both eyes of an average adult. However, the interval is not limited thereto. The first image capture device 110 and the second image capture device 120 each include an optical system and an image sensor. The optical system includes an objective lens, a zoom lens, a diaphragm, an OIS (Optical Image Stabilizer: optical hand-shake blurring compensation system) unit, and a focus lens. The optical system collects light from a subject and forms an image of the subject. The image sensor takes an image of the subject formed by the optical system and generates an image signal. The image sensor is a CCD image sensor or a CMOS image sensor. Left and right images taken by the first image capture device 110 and the second image capture device 120, respectively, are subjected to various types of image processing in the image processor 130. Image data obtained through the various types of image processing is stored in the memory card 180 via the storage medium controller 170. Here, the images that are taken may be still images or moving images.

The image processor 130 performs AD conversion, image preprocessing, and image compression processing. In the image preprocessing, various types of camera signal processing, such as gamma correction, white balance correction, and defect correction, are performed onto the image data obtained through the AD conversion. In the image compression processing, the image data is compressed by performing DCT (discrete cosine transform) and huffman coding, and the like. In the image compression processing, the image data is compressed in a compression format conforming to a specification such as MPEG-2 or H.264. It should be noted that the compression method is not limited to the format of MPEG-2 or H.264. The image processor 130 can be realized by a DSP or a microcomputer.

In the present embodiment, a configuration will be described where left and right images taken by the first image capture device 110 and the second image capture device 120 are processed by a single image processor 130. However, two image processors 130 may be provided, and an image taken by the first image capture device 110 and an image taken by the second image capture device 120 may be processed by the image processors, respectively.

The controller 140 is control means for controlling the entire stereoscopic imaging device 100. The controller 140 can be realized by a semiconductor device such as a microcomputer. The controller 140 may be implemented only by hardware or may be realized by combination of hardware and software.

Here, it is assumed that the controller 140 performs control such that the zoom magnification of the first image capture device 110 is always equal to the zoom magnification of the second image capture device 120.

The convergence point shifter 150 controls, based on an instruction from the controller 140, the OIS unit in the first image capture device 110 and the OIS unit in the second image capture device 120, thereby changing an angle of convergence between the first image capture device 110 and the second image capture device 120. Thus, the convergence point shifter 150 changes the convergence point when images are being taken.

It should be noted that the method for changing the angle of convergence between the first image capture device 110 and the second image capture device 120 is not limited to the method of controlling the OIS units. For example, by physically rotating both of, or either one of, the first image capture device 110 and the second image capture device 120, the orientations of the optical axes may be changed.

The manual interface 160 is a component collectively representing various operation means. The manual interface 160 includes a power button for turning on or off the power of the stereoscopic imaging device 100, a zoom lever for performing a zooming operation, and the like. The manual interface 160 receives an instruction by a user of a camera, and transmits the instruction to the controller 140.

The memory card 180 is attachable to and detachable from the storage medium controller 170. The storage medium controller 170 can be mechanically and electrically connected to the memory card 180. The memory card 180 includes a flash memory, a ferroelectric memory, and the like, and data can be stored therein.

In the present embodiment, a configuration will be described where the memory card 180 is attachable to and detachable from the storage medium controller 170. However, the memory card 180 may be built in the stereoscopic imaging device 100. Further, in the present embodiment, a configuration where the memory card 180 is used as a storage medium. However, the storage medium is not limited to a memory card, and may be an optical disc, a hard disk, a magnetic tape, or the like.

In the present embodiment, a configuration will be described where both of an image taken by the first image capture device 110 and an image taken by the second image capture device 120 are stored in the memory card 180. However, two memory cards 180 may be connected to the storage medium controller 170 and an image taken by the first image capture device 110 and an image taken by the second image capture device 120 may be stored in the memory cards 180, respectively.

(2. Operations of the Stereoscopic Imaging Device)

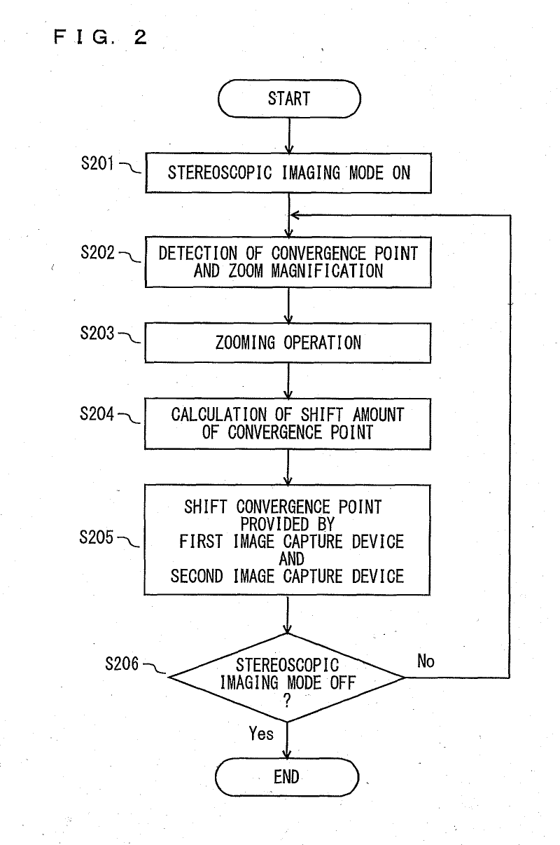

Operations performed by the stereoscopic imaging device 100 while zooming in will be described with reference to the flow chart in FIG. 2.

By the user of the camera performing an operation of turning on a stereoscopic imaging mode by means of the manual interface 160, the stereoscopic imaging device 100 enters the stereoscopic imaging mode (S201).

The controller 140 drives and moves the lenses in the first image capture device 110 and the lenses in the second image capture device 120 to their respective positions that have been saved when the power was turned off last time. Then, the controller 140 calculates a zoom magnification based on the zoom lenses in the first image capture device 110 and the second image capture device 120, and a convergence point based on an angle of convergence (S202).

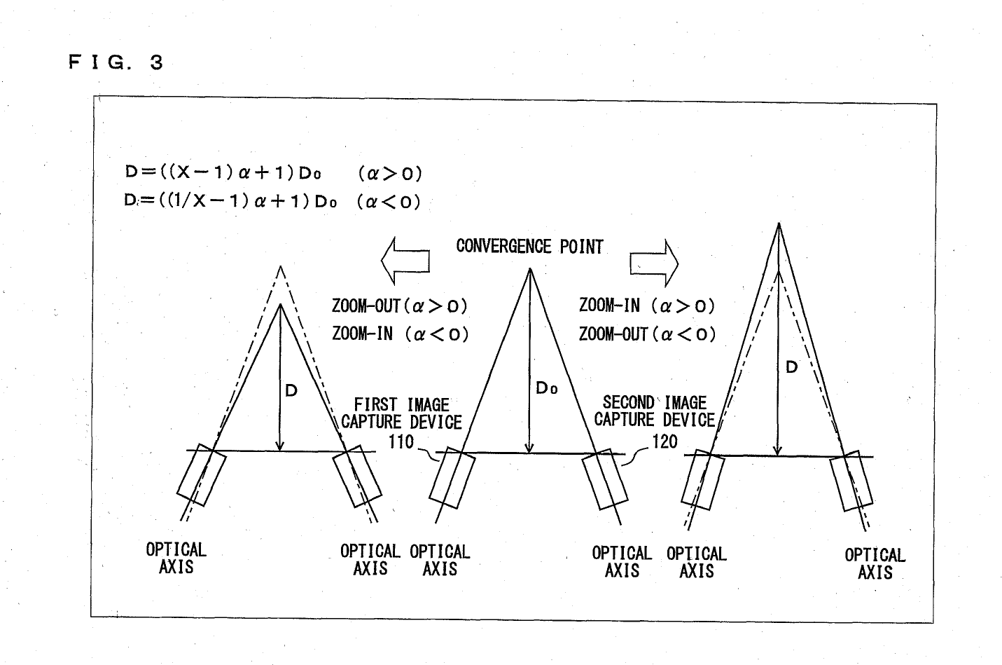

By the user of the camera performing a zooming operation by means of the manual interface 160, the stereoscopic imaging device 100 performs zooming (S203). At this time, the controller 140 controls the convergence point shifter 150 in accordance with the magnitude of the zooming operation to change the convergence point. A method for calculating a shift amount of the convergence point will be described with reference to FIG. 3.

The convergence point is calculated in accordance with the magnitude of the zooming operation, based on the following formula (S204).

D=((X−1)α+1)D₀ (α>0) (1)

D=((1/X−1)α+1)D₀ (α<0) (2)

wherein X is a change amount of the zoom magnification resulting from the zooming operation, α is a convergence point conversion factor corresponding to the zooming operation, D₀ is a convergence point before the zooming operation, D is a convergence point after the zooming operation. In the stereoscopic imaging device 100, either of a case where α>0 and a case where α<0 can be set.

X is a change amount of the zoom magnification resulting from the zooming operation, and when it is assumed that the zoom magnification before the zooming operation is Z₀ and the zoom magnification after the zooming operation is Z, X is Z/Z₀. From the above formula, the convergence point D after the zooming operation is in direct proportion to the change amount X of the zoom magnification. Therefore, the sense of projection and the sense of depth of the subject can be changed by changing the zoom magnification.

Accordingly, when an image of a subject that is viewed as if the stereoscopic imaging device 100 were approaching the subject is taken by performing a zooming operation, it is possible to present, without actually approaching the subject, an image (when α>0) providing a sense as if objects were projecting and an image (when α<0) providing a sense as if objects were receding. On the other hand, when an image that is viewed as if the stereoscopic imaging device 100 were distancing away from the subject is taken by performing a zooming operation, it is possible to present, without actually distancing away from the subject, an image (when α<0) providing a sense as if objects were receding and an image (when α>0) providing a sense as if objects were projecting.

α is a value that determines a projection amount and a depth amount for the convergence point that correspond to a given zooming operation. The sense of projection and the sense of depth can be changed in proportion to the magnitude of the value α, and it is assumed that the user can freely change the value of α.

It should be noted that the method for calculating a target value of a convergence point may not be the method shown in FIG. 3, as long as the method shifts, in accordance with the magnitude of a zooming operation, the convergence point rearward of the subject (when α>0) or frontward of the subject (when α<0) when the subject is zoomed in, and shifts the convergence point frontward of the subject (when α>0) or rearward of the subject (when α<0) when the subject is zoomed out.

Next, the controller 140 drives the convergence point shifter 150 so as to realize the target value of the convergence point, and changes the angle of convergence between the first image capture device 110 and the second image capture device 120 (S205).

By the user of the camera performing an operation of turning off the stereoscopic imaging mode by means of the manual interface 160, the stereoscopic imaging device 100 ends the stereoscopic imaging mode (S206).

(3. Summary)

The stereoscopic imaging device 100 according to the present embodiment is the stereoscopic imaging device 100 that obtains a stereoscopic image composed of a left image and a right image taken by the first image capture device 110 and the second image capture device 120, respectively, each of the first image capture device 110 and the second image capture device 120 including: a group of lenses including a variable magnification lens; and an image sensor that converts an optical image from the group of lenses into an electronic signal. The stereoscopic imaging device 100 includes: the convergence point shifter 150 that shifts a convergence point of the stereoscopic image provided by the first image capture device 110 and the second image capture device 120; and the controller 140 that controls, in accordance with a zooming operation by the manual interface 160, when a subject in the stereoscopic image is to be zoomed in, the convergence point shifter 150 to shift the convergence point rearward of the subject, and controls, when the subject in the stereoscopic image is to be zoomed out, the convergence point shifter 150 to shift the convergence point frontward of the subject. Accordingly, the convergence point can be changed in accordance with the zooming operation, while the stereoscopic image is being taken by the stereoscopic imaging device 100, and thus, the sense of projection and the sense of depth can be changed in accordance with the zooming operation. Therefore, it is possible to take an image with emphasized stereoscopic effects, without requiring additional work for changing the convergence point.

The stereoscopic imaging device according to the present embodiment can change the sense of projection and the sense of depth in accordance with a zooming operation, and can take an image with emphasized stereoscopic effects, without requiring additional work for changing the convergence point, and thus, is useful because it can be applied to a stereoscopic imaging device for business use or consumer use.

What is claimed is:

1. A stereoscopic imaging device configured to obtain a stereoscopic image composed of a left image and a right image, the stereoscopic imaging device comprising:
a first image capture device and a second image capture device configured to take the left image and the right image, respectively;
a convergence point shifter configured to shift a convergence point of the stereoscopic image provided by the first image capture device and the second image capture device; and
a controller configured to perform at least one of
controlling, in accordance with a zooming operation, when a subject in the stereoscopic image is to be zoomed in, the convergence point shifter to shift the convergence point rearward of the subject, and, when the subject in the stereoscopic image is to be zoomed out, the convergence point shifter to shift the convergence point frontward of the subject, and
controlling, in accordance with a zooming operation, when the subject in the stereoscopic image is to be zoomed in, the convergence point shifter to shift the convergence point frontward of the subject, and, when the subject in the stereoscopic image is to be zoomed out, the convergence point shifter to shift the convergence point rearward of the subject.

2. The stereoscopic imaging device according to claim 1, wherein
the controller changes the convergence point after the zooming operation, in accordance with an amount of a change of a zoom magnification after the zoom operation relative to a zoom magnification before the zoom operation.

3. A stereoscopic imaging method for obtaining a stereoscopic image composed of a left image and a right image taken by a first image capture device and a second image capture device, the method comprising:
a convergence point shifting step of shifting a convergence point of the stereoscopic image provided by the first image capture device and the second image capture device; and
a control step of performing at least one of
controlling, in accordance with a zooming operation, when a subject in the stereoscopic image is to be zoomed in, the convergence point shifting step to shift the convergence point rearward of the subject, and, when the subject in the stereoscopic image is to be zoomed out, the convergence point shifting step to shift the convergence point frontward of the subject, and
controlling, in accordance with a zooming operation, when the subject in the stereoscopic image is to be zoomed in, the convergence point shifting step to shift the convergence point frontward of the subject, and, when the subject in the stereoscopic image is to be zoomed out, the convergence point shifting step to shift the convergence point rearward of the subject.
